(19) United States
(12) Patent Application Publication
(10) Pub. No.: US 2005/0143535 A1
(43) Pub. Date: Jun. 30, 2005

(54) Coating with volatile-free aminoplast crosslinker

(75) Inventor: Donald H. Campbell, Hartland, MI (US)

Correspondence Address: BASF CORPORATION;ANNE GERRY SABOURIN, 26701 TELEGRAPH ROAD, SOUTHFIELD, MI, 48034-2442, US

(73) Assignee: BASF Corporation, Southfield, MI (US)

(21) Appl. No.: 11/062,987

(22) Filed: Feb. 22, 2005

Related U.S. Application Data
(63) Continuation of application No. 10/065,066, filed on Sep. 13, 2002.

(51) Int. Cl. C08L 61/20

(52) U.S. Cl. 525/509

(57) ABSTRACT

A thermosettable powder coating composition of solid particulates having, in admixture, an oxazolidine blocked aminoplast and an active hydrogen functional material does not generate a volatile by-product on curing.

### FIELD OF THE INVENTION

This invention concerns coating compositions containing aminoplast materials, especially powder coating compositions.

### BACKGROUND OF THE INVENTION

Aminoplasts are thermosetting materials based on the reaction of an amine with an aldehyde and the related acetals containing amines or amides. Aminoplasts having many uses, including molding, adhesives, laminating resins such as for countertops and tabletops, textile finishes, permanent-press fabrics, wash-and-wear apparel fabrics, protective coatings, paper finishes, leather treatment, binders for fabrics, foundry sands, graphite resistors, plaster-of-paris fortification, foam structures, and ion-exchange resins.

Aminoplast resins have been used extensively in thermosetting coating compositions. The aminoplast resins for coatings generally are modified by reacting the methylol groups formed by reaction of the amine and formaldehyde (or corresponding alkylol groups from reaction with another aldehyde) with one or more alcohols to provide alkyloxy groups. The reaction with an alcohol is commonly called “alkylation” and the product is commonly called an “alkylated” aminoplast resin. An aminoplast resin may be alkylated, for example, to make it more compatible in the thermosetting composition and/or to reduce its reactivity so that the composition has storage stability. When the thermosetting composition containing the alkylated aminoplast resin is cured, the alkylating alcohol is displaced by an active hydrogen group of a polymer or resin in the composition and the displaced alcohol is volatilized.

Powder coating compositions have become increasingly important for automotive coatings and other applications because they give off very little or no volatile material to the environment when cured. Typically, any such emissions are limited to by-products of the curing reaction, such as blocking agents or volatile condensation products. Powder coatings have found use as both decorative coatings and protective coatings.

Powder coatings typically contain hydroxyl, carboxyl, carbamate and/or epoxy functional resins, such as acrylic and polyester resins having relatively high glass transition temperatures as film-forming polymers. Because vinyl (e.g., acrylic) polymer systems can be more heat-resistant than condensation polymers, they can provide powder coating compositions having improved storage stability. By “storage stability” is meant the ability of the individual powder particles which comprise the powder coating to resist the +tendency to adhere to one another, thereby causing “sintering” or “fusing” of the powder coating composition upon storage prior to application. Powder coating compositions having very poor storage stability can be difficult, if not impossible, to apply once sintering has occurred.

Aminoplast resins are well known in the art as low cost crosslinking agents for hydroxyl, carboxyl and/or carbamate functional polymers in conventional liquid coating compositions. Attempts to produce powder coating compositions based on conventional aminoplast resins, however, have been largely unsatisfactory because these materials are typically in liquid form and, as such, cause poor powder stability even at low levels. The methoxylated aldehyde condensates of glycoluril, which are solid products, are the aminoplast resins most commonly employed as crosslinking agents in powder coating compositions. Although solid in form, these materials or other conventional coatings aminoplast resins nonetheless generate volatile emissions during curing due to evolution of the alkylating alcohol. Gassing occurs as a result of vaporization of the alcohol. The alcohol vapor is driven off through the coating film upon heating and, as the viscosity of the coating increases during the curing process, pinholes or craters are formed as the gas escapes through the coating surface.

Aarts, U.S. Pat. No. 5,103,003, discloses a preparation for 3-(1,3-oxazolidinyl)-s-triazine and its use as a crosslinker in polymerization reactions. The Aarts patent reports a “surprisingly high yield” by its method, reporting 1.4 grams of product obtained from 4.9 grams of N,N′,N″-tris(2-hydroxyethyl)melamine in Example 1 (less than 30% yield). The Aarts patent mentions using the 3-(1,3-oxazolidinyl)-s-triazine as a crosslinking agent in polymerization reactions but does not mention or discuss other uses or compositions such as coatings.

Carbamate functional polymers, that is, polymers having reactive pendent and/or terminal carbamate functional groups, are well known in the art as suitable film-forming resins for liquid coating systems where, for example, when combined with an aminoplast curing agent, they provide coatings having excellent acid etch resistance. The carbamate NH groups react readily with the methoxy groups of the aminoplast resin, thereby forming a urethane linkage that provides this acid etch resistance. These carbamate functional polymers further provide coatings that have excellent durability and adhesion properties.

It would thus be desirable to formulate powder coatings, particularly using carbamate-functional materials, that could be cured without generating volatile organic byproducts.

### SUMMARY OF THE INVENTION

The invention provides a thermosettable powder coating composition comprising solid particulates comprising, in admixture, an oxazolidine blocked aminoplast and an active hydrogen functional material. The oxazolidine blocked aminoplast reacts with the active hydrogen functional polymer to cure the coating composition without producing volatile emissions or the pinholing or other coating defects associated with outgassing of a volatile by-product.

“A” and “an” as used herein indicate “at least one” of the item is present; a plurality of such items may be present, when possible. “About” when applied to values indicates that the calculation or the measurement allows some slight imprecision in the value (with some approach to exactness in the value; approximately or reasonably close to the value; nearly). If, for some reason, the imprecision provided by “about” is not otherwise understood in the art with this ordinary meaning, then “about” as used herein indicates a possible variation of up to 5% in the value.

### DETAILED DESCRIPTION OF THE PREFERRED EMBODIMENTS

The following description of the preferred embodiment(s) is merely exemplary in nature and is in no way intended to limit the invention, its application, or uses.

The thermosettable powder coating composition of the invention provides solid particulates containing at least an oxazolidine blocked aminoplast and an active hydrogen-functional material.

Aminoplast resins may be prepared by reaction of an aldehyde with a compound containing a primary amine group. Although formaldehyde is the most widely used aldehyde commercially, other suitable aldehydes include, without limitation, acetaldehyde, propionaldehyde, butyraldehyde, crotonaldehyde, and benzaldehyde.

The compound with a primary amine group is preferably selected from melamine, urea, benzoguanamine, acetoguanamine, and glycouril. In one preferred embodiment, the compound with an amine group has two or more primary amine groups.

The oxazolidine-blocked aminoplast resin may also be prepared by reacting an isocyanate-functional compound with oxazolidine or an alkyl-substituted oxazolidine, preferably oxazolidine, methyl oxazolidine, or 2,2 dimethyl, oxazolidine. The latter material is commercially available as CS1135 from Angus(Dow) Chemical as a 78% solution in water. The isocyanate-functional compound has two or more, preferably three or more, isocyanate groups. Suitable examples of such polyisocyanate compounds include, without limitation, diisocyanates such as alkylene diisocyanates including hexamethylene diisocyanate and isophorone diisocyanate; biurets, isocyanurates, and allophanates of diisocyanates; triisocyanates such as 4-isocyanatomethyl-1,8-octamethylene diisocyanate and 4,4′,4″-triphenylmethane triisocyanate, 1,3,5-benzene triisocyanate and 2,4,6-toluene triisocyanate; and polymeric polyisocyanates, such as copolymers of isocyanatoethyl methacrylate and polymethylene polyphenyl isocyanate.

The thermosettable powder coating composition further includes an active hydrogen-functional material. The active hydrogen functionality is selected to be reactive with the aminoplast resin. Suitable examples of active hydrogen functionality include, without limitation, hydroxyl, carbamate, urea, amide, amine, carboxylic acid, and thiol groups, as well as combinations of these groups. The material should have at least two active hydrogen groups and should be a solid at about 25° C., preferably a solid at about 40° C. The material may be monomeric, oligomeric, or polymeric.

Suitable examples of monomeric active hydrogen-functional materials include, without limitation, crystalline polyols such as those described in Clark et al, U.S. Pat. No. 5,552,487; solid, carbamate-functional compounds such as the solid reaction products of polyisocyanates with an amino carbamate or hydroxy carbamate compound, as provided by Rehfuss and Ohrbom, U.S. Pat. No. 5,512,639; and solid dicarboxylic acids, such as maleic acid, malonic acid, and isophthalic acid.

Suitable examples of oligomeric and polymeric active hydrogen-functional materials include, without limitation, polyesters, polyurethanes, vinyl copolymers including acrylic copolymers and addition copolymers of any alpha, beta-unsaturated monomers.

Suitable active hydrogen-functional polyesters may be prepared by the reaction of one or more polyols, preferably one or more diols, with one or more polyacids, preferably one or more diacids, or anhydride(s) of such acids. The polyol or polyols used to prepare the polyester can be selected from any of the polyols known to be useful in preparing polyesters, including, without limitation, 1,4-butanediol, 1,3-butanediol, 2,3-butanediol, 1,6-hexanediol, neopentyl glycol, 1,3-propanediol, 1,5-pentanediol, 1,6-hexanediol, 1,9-nonanediol, ethylene glycol, diethylene glycol, triethylene glycol and tetraethylene glycol, propylene glycol, dipropylene glycol, glycerol, cyclohexanedimethanols, 2-methyl-2-ethyl-1,3-propanediol, 2-ethyl-1,3-hexanediol, thiodiglycol, 2,2,4-trimethyl-1,3-pentanediol, cyclohexanediols, trimethylolpropane, trimethylolethane, and glycerin. The polyacids or anhydrides of polyacids may be selected from any of those known to be useful in preparing polyesters, including, without limitation, malonic acid, maleic acid, succinic acid, glutaric acid, adipic acid, azelaic acid, phthalic acid, terephthalic acid, isophthalic acid, anhydrides thereof, and combinations thereof. The polyester may have acid functionality or alcohol functionality by polymerizing with excess equivalents of (respectively) the polyacid component or the polyol component. The polyester may have other active hydrogen functional groups by polymerizing with polyacids or polyols having such a hydrogen functional group that does not react with carboxylic acid or alcohol under the polymerization conditions (for example, polymerization using an amino alcohol under conditions conducive to esterification and at which amidification does not occur) or by adducting the polyester with a compound having such active hydrogen functionality and further having a group reactive with functionality on the polyester. The polyester reactants are selected and apportioned to provide a solid polymer suitable for a powder coating composition.

Suitable active hydrogen-functional polyurethanes may be prepared by reaction of at least one polyisocyanate and at least one polyol. The reactants used to prepare the polyurethane are selected and apportioned to provide a solid polyurethane suitable for use in a powder coating composition. Suitable polyisocyanates include, without limitation, aliphatic linear and cyclic polyisocyanates, preferably having up to 18 carbon atoms, and substituted and unsubstituted aromatic polyisocyanates. Illustrative examples include, without limitation, ethylene diisocyanate, 1,2-diisocyanatopropane, 1,3-diisocyanatopropane, 1,4-butylene diisocyanate, lysine diisocyanate, 1,4-methylene bis(cyclohexyl isocyanate), isophorone diisocyanate, toluene diisocyanates (e.g., 2,4-toluene diisocyanate and 2,6-toluene diisocyanate) diphenylmethane 4,4′-diisocyanate, methylenebis-4,4′-isocyanatocyclohexane, 1,6-hexamethylene diisocyanate, p-phenylene diisocyanate, tetramethyl xylene diisocyanate, meta-xylene diisocyanate, 2,2,4-trimethyl-1,6-hexamethylene diisocyanate, 1,12-dodecamethylene diisocyanate, cyclohexane-1,3- and -1,4-diisocyanate, 1-isocyanato-2-isocyanatomethyl cyclopentane, and combinations of two or more of these. Biurets, allophanates, isocyanurates, carbodiimides, and other such modifications of these isocyanates can also be used as the polyisocyanates. In a preferred embodiment, the polyisocyanates include methylenebis-4,4′-isocyanatocyclohexane, 1,6-hexamethylene diisocyanate, 1,12-dodecamethylene diisocyanate, and combinations thereof. It is particularly preferred to use at least one alpha, omega-alkylene diisocyanate having four or more carbons, preferably 6 or more carbons, in the alkylene group. Combinations of two or more polyisocyanates in which one of the polyisocyanates is 1,6-hexamethylene diisocyanate are especially preferred.

The polyol or polyols used to prepare the polyurethane polymer can be selected from any of those already mentioned, as well as polyester polyols such as the reaction products of any of the foregoing polyols and polyacids reacted to provide hydroxyl-functional polyesters; polyether polyols, such as polyethylene glycols and polypropylene glycols; and combinations of such polyols. Polyols having two hydroxyl groups are preferred.

Suitable polyurethane polymers can be prepared by any of the known methods. In one method for preparing polyurethane polymers, the polyisocyanate component is reacted with an excess of equivalents of the polyol component to form a hydroxyl-functional polyurethane polymer. Alternatively, an excess of equivalents of the polyisocyanate component can be reacted with the polyol component to form an isocyanate-functional prepolymer. The prepolymer can then be reacted further in different ways. The prepolymer can be reacted with a polyfunctional polyol, polyamine, or amino alcohol compound to provide reactive hydrogen functionality. Examples of such polyfunctional compounds include, without limitation, the polyols already mentioned above, including triols such as trimethylolpropane; polyamines such as ethylenediamine, butylamine, and propylamine; and amino alcohols, such as diethanolamine. Acid-functional polyurethanes may be synthesized by including a monomer having acid functionality, such as, without limitation, dialkylpropionic acids including dimethylolpropionic acid, and alkali metal salts of amino acids such as taurine, methyl taurine, 6-amino caproic acid, glycine, sulfanilic acid, diamino benzoic acid, ornithine, lysine and 1:1 adducts of sultones, such as propane sultone or butane sultone, with diamines, such as ethylene diamine, hydrazine, or 1,6-hexamethylene diamine. The hydroxyl or amine groups react with the isocyanate while the acid group remains unreacted.

Hydroxyalkyl carbamates such a hydroxyethyl carbamate, hydroxypropyl carbamate, and hydroxybutyl carbamate are most preferred for capping of an isocyanate-functional prepolymer.

Suitable examples of vinyl copolymers, acrylic copolymers, and addition copolymers of alpha, beta-unsaturated monomers are homopolymers and copolymers of active hydrogen-functional monomers. Suitable examples of active hydrogen-functional addition polymerizable monomers include, without limitation, hydroxyl-functional monomers such as hydroxyethyl acrylate, hydroxyethyl methacrylate, hydroxypropyl acrylate, hydroxypropyl methacrylate, hydroxybutyl acrylates, and hydroxybutyl methacrylates; vinyl acetate, which is hydrolyzed after polymerization to the alcohol; carbamate- and urea-functional monomers or monomers with functional groups that are converted to carbamate or urea groups after polymerization such as, without limitation, those disclosed in U.S. Pat. No. 5,866,259, “Primer Coating Compositions Containing Carbamate-Functional Acrylic Polymers,” the entire disclosure of which is incorporated herein by reference; acid-functional monomers such as α,β-ethylenically unsaturated monocarboxylic acids containing 3 to 5 carbon atoms, α,β-ethylenically unsaturated dicarboxylic acids containing 4 to 6 carbon atoms and the anhydrides and monoesters of these, such as acrylic acid, methacrylic acid, crotonic acid, maleic acid or maleic anhydride, itaconic acid or itaconic anhydride, and so on; acrylic and methacrylic amides and aminoalkyl amides including, without limitation, acrylamide, N-(1,1-dimethyl-3-oxobutyl)-acrylamide, N-alkoxy amides such as methylolamides; N-alkoxy acrylamides such as n-butoxy acrylamide; N-aminoalkyl acrylamides or methacrylamides such as aminomethylacrylamide, 1-aminoethyl-2-acrylamide, 1-aminopropyl-2-acrylamide, 1-aminopropyl-2-methacrylamide, N-1-(N-butylamino)propyl-(3)-acrylamide and 1-aminohexyl-(6)-acrylamide and 1-(N,N-dimethylamino)-ethyl-(2)-methacrylamide, 1-(N,N,-dimethylamino)-propyl-(3)-acrylamide and 1-(N,N-dimethylamino)-hexyl-(6)-methacrylamide; and so on.

In addition to the ethylenically unsaturated monomer having active hydrogen functionality or used to generate active hydrogen functionality in the finished polymer, one or more other ethylenically unsaturated monomers are typically employed as comonomers in forming the acrylic resins. Examples of such copolymerizable monomers include, without limitation, derivatives of α,β-ethylenically unsaturated monocarboxylic acids containing 3 to 5 carbon atoms, including esters of those acids; diesters of α,β-ethylenically unsaturated dicarboxylic acids containing 4 to 6 carbon atoms; vinyl esters, vinyl ethers, vinyl ketones, and aromatic or heterocyclic aliphatic vinyl compounds. Representative examples of esters of acrylic, methacrylic, and crotonic acids include, without limitation, those esters from reaction with saturated aliphatic and cycloaliphatic alcohols containing 1 to 20 carbon atoms, such as methyl, ethyl, propyl, isopropyl, n-butyl, isobutyl, tert-butyl, 2-ethylhexyl, lauryl, stearyl, cyclohexyl, trimethylcyclohexyl, tetrahydrofurfuryl, stearyl, sulfoethyl, and isobornyl acrylates, methacrylates, and crotonates; and polyalkylene glycol acrylates and methacrylates. Representative examples of vinyl monomers that can be copolymerized include, without limitation, such compounds as vinyl acetate, vinyl propionate, vinyl ethers such as vinyl ethyl ether, vinyl and vinylidene halides, and vinyl ethyl ketone. Representative examples of aromatic or heterocyclic aliphatic vinyl compounds include, without limitation, such compounds as styrene, α-methyl styrene, vinyl toluene, tert-butyl styrene, and 2-vinyl pyrrolidone.

The oligomeric and polymeric active hydrogen-functional materials are solids suitable for formulation into powder coatings. Typically, materials suitable for formulation into powder coatings have glass transition temperatures or melting points above room temperature, preferably at least about 30° C., more preferably at least about 40° C.

The thermosettable powder coating composition may include a wide range of weight ratios of the oxazolidine blocked aminoplast resin to the active hydrogen-functional material. In general, the oxazolidine blocked aminoplast resin may be from about 1% by weight to about 50% by weight of the total weight of oxazolidine blocked aminoplast resin and active hydrogen-functional material. The oxazolidine blocked aminoplast resin is preferably from about 5% by weight to about 40% by weight, and more preferably from about 5% by weight to about 20% by weight, of the total weight of oxazolidine blocked aminoplast resin and active hydrogen-functional material. Alternatively, the equivalent ratio of the oxazolidine blocked aminoplast resin to the active hydrogen-functional material may be from about 0.20 to about 5.0 equivalents, preferably from about 0.5 to about 2.0 equivalents of oxazolidine blocked aminoplast resin to each equivalent of active hydrogen-functional material.

In one embodiment, a second crosslinking agent is present in the coating composition. The second crosslinking agent may be reactive with the active hydrogen functionality or with other functionality on the active hydrogen-functional material or on a further thermosettable material. For example, the second crosslinking agent may have oxriane groups and be reactive with amine or acid groups of the hydrogen-functional material. The crosslinking of these two resins produces a hydroxyl that can be further reacted with the aminoplast materials of the present invention.

Second crosslinkers capable of reacting with active hydrogen compounds include isocyanate-functional crosslinking agents, blocked isocyanate crosslinking agents, and conventional aminoplasts. Blocked isocyanates can include lactam, pyrazole, triazole, oxime, amine and/or alcohol blocked isocyanates. Alcohol blocked isocyanates can include triazinyl compounds such as TACT® from Cytec. Blocked isocyanates can also include malonate reacted isocyanates, which react by transesterification. This additional crosslinker can react with the active hydrogen on the active hydrogen containing compound, and/or it can react with the hydroxyl group that is liberated by the opening of oxazolidine during reaction of the oxazolidine-blocked aminoplast resin.

Additional crosslinking mechanisms may also have a single, self-crosslinkable component. An example of this is a silane functional resin. Even such resin can also interact with the current crosslinker by trans-reaction of the silyl esters with hydroxy groups formed by the oxazolidine ring opening.

It may be desirable to incorporate into the powder coating composition other materials, such as fillers, pigments, leveling agents to help coalesce the film, plasticizers, air release agents such as benzoin, flow agents such as poly(butyl acrylates) and poly(2-ethylhexyl acrylates), poly(methyl methacrylates), hindered amine light stabilizers and ultraviolet light absorbers, antioxidants, and/or catalysts. Moreover, a texturing agent may also be included, for example to more finely adjust the degree of texture.

Pigments and fillers may be utilized in amounts typically of up to 40% by weight, based on total weight of the coating composition. The pigments used may be inorganic pigments, including metal oxides, chromates, molybdates, phosphates, and silicates. Examples of inorganic pigments and fillers that could be employed are titanium dioxide, barium sulfate, carbon black, ocher, sienna, umber, hematite, limonite, red iron oxide, transparent red iron oxide, black iron oxide, brown iron oxide, chromium oxide green, strontium chromate, zinc phosphate, silicas such as fumed silica, calcium carbonate, talc, barytes, ferric ammonium ferrocyanide (Prussian blue), ultramarine, lead chromate, lead molybdate, and mica flake pigments. Organic pigments may also be used. Examples of useful organic pigments are metallized and non-metallized azo reds, quinacridone reds and violets, perylene reds, copper phthalocyanine blues and greens, carbazole violet, monoarylide and diarylide yellows, benzimidazolone yellows, tolyl orange, naphthol orange, and the like.

Hindered amine light stabilizers, ultraviolet light absorbers, and anti-oxidants may be added in ways and amounts known to the art to augment the durability of the finished coating, and are particularly useful when the finished coating may be subjected to outdoor exposure.

Examples of suitable catalysts include, without limitation, strong acid catalysts which include phosphate esters, sulfate esters, and sulfonic, phosphonic sulfonamide catalysts.

The thermosetting powder coating compositions can be prepared by first melt blending the ingredients of the coating compositions. This process usually involves dry blending the ingredients in a planetary mixer and then melt blending the admixture in an extruder at a suitable temperature. The extrusion temperature is preferably chosen so that it is high enough to allow the resin to melt to a viscosity that produces good mixing and pigment wetting, but is not so high that any significant amount of co-reaction between resin and crosslinker occurs. The melt blending is usually carried out within the range of from 80° C. to 130° C.

The extrudate is then cooled and pulverized. The extrudate may be crushed to a fine flake or granule and then ground by typical methods employed in the art, and classified by sieving or other means. The maximum particle size and the particle size distribution are controlled in the classifying step and affect the smoothness of the final film. Requirements for these parameters depend upon the particular use and application method.

The thermosetting powder coating composition can be applied onto many different substrates, including metal substrates such as bare steel, phosphated steel, galvanized steel, or aluminum; and non-metallic substrates, such as plastics and composites. The substrate may also be any of these materials having upon it already a layer of another coating, such as a layer of an electrodeposited primer, cured or uncured before the application of the powder coating compositions.

Application can be, for example, by electrostatic spraying or by use of a fluidized bed. Electrostatic spraying is the preferred method. The coating powder can be applied in one or more passes to provide a film thickness after cure of typically from about 20 to about 100 microns. The substrate can optionally be preheated prior to application of a powder coating composition to promote uniform and thicker powder deposition.

After application of the coating composition to the substrate, the coating is cured, preferably by heating at a temperature and for a length of time sufficient to cause the reactants to form an insoluble polymeric network. The cure temperature is usually from about 145° C. to about 205° C., and the length of cure is usually about 15 minutes to about 60 minutes. Preferably, the coating is cured at about 150° C. to about 180° C. for about 20 to about 30 minutes. Heating can be done in infrared and/or convection ovens.

The powder coating composition of the invention can be formulated as a primer coating composition, a basecoat coating composition, or a clearcoat coating composition. Basecoat coating compositions include appropriate pigments to provide the desired color and/or special effect to the coating layer. Clearcoat coating compositions do not include opaque pigments.

The invention is further described in the following example. The examples are merely illustrative and do not in any way limit the scope of the invention as described and claimed. All parts are parts by weight unless otherwise noted.

### EXAMPLE 1

### Preparation of Coating of the Invention

The following dry materials were dry blended: 50 grams of 2,4,6-tri-3-(4-methyl-1,3-oxazolidinyl)-s-triazine, 40 grams of 2,4,6-tri-3-(1,3-oxazolidinyl)-s-triazine, 132 grams of a carbamate-functional polyurethane (reaction product of 1029 parts by weight DESMODUR N3300 form Bayer (an isocyanurate of hexamethylene diisocyanate) and 523.6 parts by weight hydroxyethyl carbamate), 282 grams of a carbamate-functional acrylic polymer (polymerization product of 376.3 parts by weight 2,3-carbonatopropyl methacrylate, 53.8 parts by weight styrene, 231.3 parts by weight butyl acrylate, 588.8 parts by weight methyl methacrylate reacted with ammonia, weight average molecular weight of 4482), 300 grams of titanium dioxide, 4 grams of Cylink TSI (obtained from Cytec Industries), and 1.6 grams benzoin. The mixture was processed at 250 RPM through a ZSK-30 twin screw extruder (obtained from Werner & Pfleiderer having a first zone temperature of 105° C. and a second zone temperature of 105° C. The extrudate was cooled and pulverized in a Retch mill at low speed, then classified with a sieve, 90 micron maximum particle size, to produce a powder coating.

The powder coating was applied onto both uncoated steel and electrocoat primed steel substrates using an electrostatic spray gun. The applied coating was cured in a convection oven at 340° F. for 20 minutes. Both coated panels were well cured (>100 doublerubs with isopropanol).

### EXAMPLE 2

### Preparation of Oxazolidine Blocked Urea Compound

A suitable flask having a nitrogen blanket was charged with 215 grams of Desmodur Z 4470 AA (70% by weight of the isocyanurate of isophorone diisocyanate/30% by weight amyl acetate, obtained from Bayer). The contents of the flask was heated to 70° C., then 166.2 grams of a 46.5% by weight solution of oxazolidine in toluene (previously dried by refluxing to remove any water) was added dropwise, maintaining the temperature of the reaction mixture below about 95° C. When the addition was complete, the reaction mixture was heated to 100° C. and held at that temperature until infrared spectroscopy showed no peak at 2250 cm⁻¹. The solvent was removed by vacuum distillation to yield a solid product of oxazolidine blocked urea compound.

A coating composition is prepared according to Example 1 by replacing the 2,4,6-tri-3-(4-methyl-1,3-oxazolidinyl)-s-triazine with the oxazolidine blocked urea compound on an equivalent-for-equivalent basis. The powder coating is applied to steel and electrocoat primed steel substrates and cured in the same way as described for Example 1.

The invention has been described in detail with reference to preferred embodiments thereof. It should be understood, however, that variations and modifications can be made within the spirit and scope of the invention.

1. A thermosettable powder coating composition comprising solid particulates comprising, in admixture, an oxazolidine blocked aminoplast and an active hydrogen functional material.

2. A thermosettable powder coating composition according to claim 1, wherein the aminoplast is selected from the group consisting of the reaction products of aldehydes with melamine, urea, benzoguanamine, acetoguanamine, and glycouril compounds.

3. A thermosettable powder coating composition according to claim 1, wherein the oxazolidine-blocked aminoplast resin is the reaction product of a polyisocyanate-functional compound with oxazolidine or an alkyl-substituted oxazolidine.

4. A thermosettable powder coating composition according to claim 3, wherein the polyisocyanate-functional compound is a member selected from the group consisting of diisocyanates, biurets, isocyanurates, and allophanates of diisocyanates, triisocyanates, and polymeric polyisocyanates.

5. A thermosettable powder coating composition according to claim 1, wherein the active hydrogen functional material comprises as functional groups a member selected from the group consisting of hydroxyl, carbamate, urea, amide, amine, carboxylic acid, and thiol groups and mixtures thereof.

6. A thermosettable powder coating composition according to claim 1, wherein the active hydrogen functional material comprises a monomeric active hydrogen-functional compound.

7. A thermosettable powder coating composition according to claim 6, wherein the monomeric active hydrogen functional material comprises a reaction product of a polyisocyanate with an amino carbamate or hydroxy carbamate compound.

8. A thermosettable powder coating composition according to claim 1, wherein the active hydrogen functional material comprises a polymer selected from the group consisting of polyesters, polyurethanes, vinyl copolymers, addition copolymers, and combinations thereof.

9. A thermosettable powder coating composition according to claim 8, wherein the polymer comprises hydroxyl groups, carbamate groups, urea groups, carboxylic acid groups, or a combination thereof.

10. A thermosettable powder coating composition according to claim 1, wherein the equivalent ratio of the oxazolidine blocked aminoplast resin to the active hydrogen-functional material is from about 0.20 to about 5.0 equivalents of oxazolidine blocked aminoplast resin to each equivalent of active hydrogen-functional material.

11. A thermosettable powder coating composition according to claim 1, wherein the equivalent ratio of the oxazolidine blocked aminoplast resin to the active hydrogen-functional material is from about 0.5 to about 2.0 equivalents of oxazolidine blocked aminoplast resin to each equivalent of active hydrogen-functional material.

12. A thermosettable powder coating composition according to claim 1, comprising a further material reactive with active hydrogen functionality.

13. A thermosettable powder coating composition according to claim 1, comprising a further thermosettable materials reactive with one another.

14. A method of coating a substrate, comprising steps of applying a thermosettable powder coating composition according to claim 1 to a substrate and curing the applied composition to provide a coating on the substrate.

15. A coated substrate prepared according to the method of claim 14.
